(19) United States
(12) Patent Application Publication
(10) Pub. No.: US 2022/0279776 A1
(43) Pub. Date: Sep. 8, 2022

(54) Tree Stand Rail Assembly

(71) Applicant: Richard Spurlock, Shelbyville, IN (US)

(72) Inventor: Richard Spurlock, Shelbyville, IN (US)

(21) Appl. No.: 17/192,492

(22) Filed: Mar. 4, 2021

(51) Int. Cl. A01M 31/02

(52) U.S. Cl. CPC A01M 31/02

(57) ABSTRACT

A tree stand rail assembly includes a pair of brackets that each has an adjustable width to match a width of a tree stand. Each of the brackets has an adjustable height to match a height of a user standing on the tree stand. A pair of side rail units each slidably engages each of the brackets such that each of the side rail units has a horizontally oriented element to inhibit a user from falling sideways from the tree stand. An arm is pivotally coupled to a respective one of the side rail units. The arm is positionable in a closed position having the arm extending horizontally between the side rail units to inhibit the user from falling forwardly from the tree stand. The arm is positionable in an open position has the arm to facilitate the user to enter or exit the tree stand.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tree stand devices and more particularly pertains to a new tree stand device for inhibiting a user from falling off of a tree stand. The device includes a pair of brackets that mount to a frame of a tree stand and a pair of side rails that attach to the brackets. Additionally, an arm is pivotally coupled to one of the side rails to extend across the side rails.

### (2) Description of Related Art Including Information Disclosed Under 37 CFR 1.97 and 1.98

The prior art relates to tree stand devices including a variety of tree stands that include a safety railing to inhibit a user from falling out of the tree stand. The prior art discloses a variety of tree mounted chairs that have a safety rail for inhibit a user from falling out of the tree mounted chairs. In no instance does the prior art disclose a safety rail that is universally attachable to a variety of existing tree stands.

### BRIEF SUMMARY OF THE INVENTION

An embodiment of the disclosure meets the needs presented above by generally comprising a pair of brackets that each has an adjustable width to match a width of a tree stand. Each of the brackets has an adjustable height to match a height of a user standing on the tree stand. A pair of side rail units each slidably engages each of the brackets such that each of the side rail units has a horizontally oriented element to inhibit a user from falling sideways from the tree stand. An arm is pivotally coupled to a respective one of the side rail units. The arm is positionable in a closed position having the arm extending horizontally between the side rail units to inhibit the user from falling forwardly from the tree stand. The arm is positionable in an open position has the arm to facilitate the user to enter or exit the tree stand.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tree stand assembly according to an embodiment of the disclosure.

FIG. 2 is a right side view of an embodiment of the disclosure.

FIG. 3 is a front view of an embodiment of the disclosure.

FIG. 4 is a left side view of an embodiment of the disclosure.

FIG. 5 is a perspective in-use view of an embodiment of the disclosure.

### DETAILED DESCRIPTION OF THE INVENTION

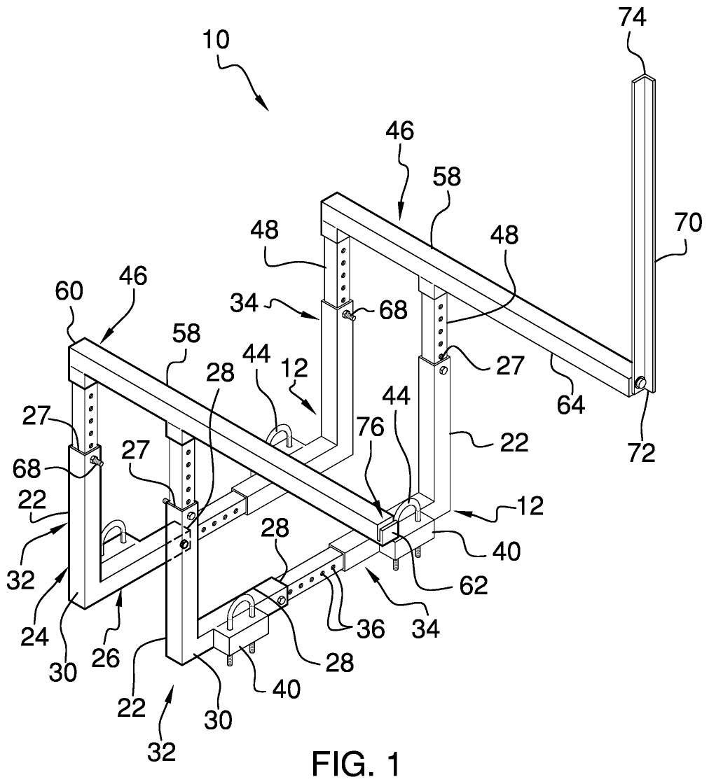

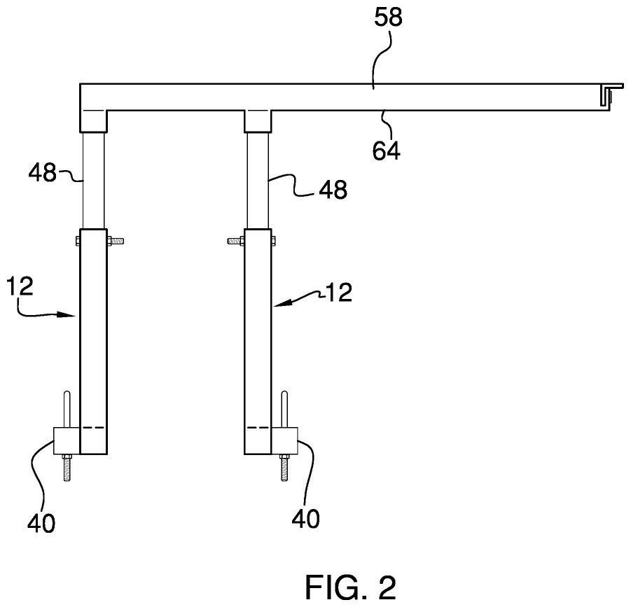

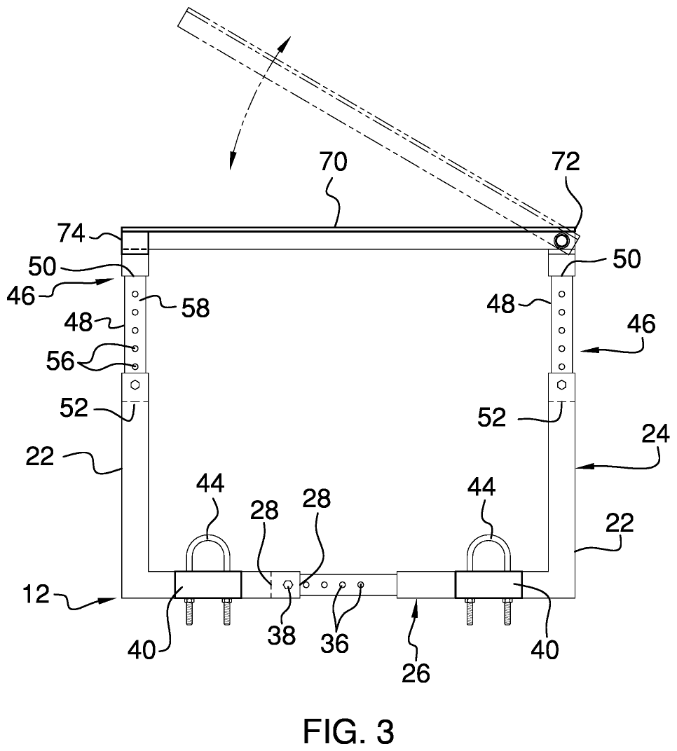

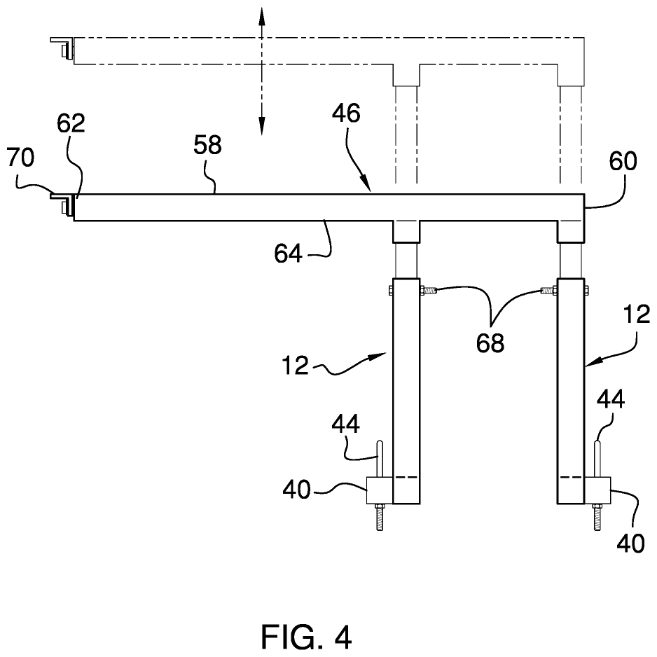

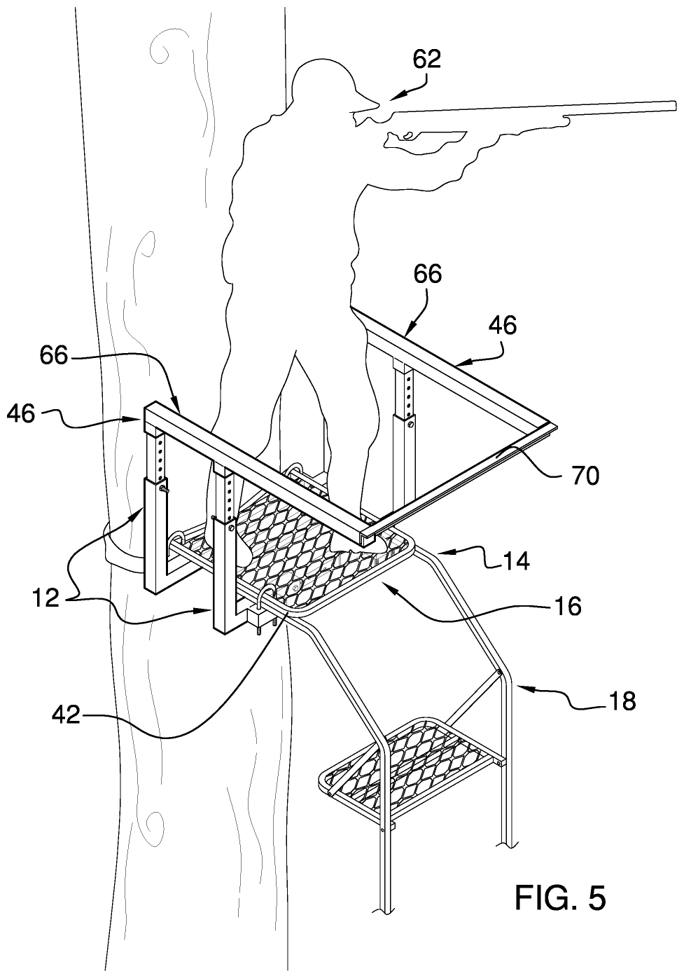

With reference now to the drawings, and in particular to FIGS. 1 through 5 thereof, a new tree stand device embodying the principles and concepts of an embodiment of the disclosure and generally designated by the reference numeral 10 will be described.

As best illustrated in FIGS. 1 through 5, the tree stand rail assembly 10 generally comprises a pair of brackets 12 that each has an adjustable width thereby facilitating each of the brackets 12 to be adjusted to match a width of a tree stand 14. The tree stand 14 may be a hunting tree stand of any conventional design that includes a platform 16 and a ladder 18. Each of the brackets 12 has an adjustable height to match a height of a user 20 standing on the tree stand 14. Each of the brackets 12 comprises a pair of tubes 22 that each has a first portion 24 forming an angle with a second portion 26. Each of the tubes 22 has a first end 27, a second end 28 and an outer wall 30 extending therebetween. The first end 27 is associated with the first portion 24 and the second end 28 is associated with the second portion 26.

The pair of tubes 22 includes a first tube 32 and a second tube 34. The first end 27 of the first tube 32 insertably receives the first end 27 of the second tube 34 such that the second portion 26 of each of the tubes 22 is positionable an adjustable distance apart from each other. The outer wall 30 of the first portion 24 of the second tube 34 has a plurality of apertures 36 extending therethrough, and the apertures 36 are distributed over a substantial length of the first portion 24. Each of the brackets 12 includes a pin 38 that is extendable through the outer wall 30 of the first portion 24 of the first tube 32. The pin 38 engages a respective one of the apertures 36 in the outer wall of the first portion 24 of the second tube 34 for retaining the first tube 32 and the second tube 34 at a selected width.

Each of the brackets 12 includes a pair of blocks 40 and each of the blocks 40 is coupled to and extending away from the outer wall corresponding to the first portion 24 of a respective one of the tubes 22. Each of the blocks 40 is positionable a selected distance apart from each other when the first tube 32 and the second tube 34 are positioned at a selected width. In this way the blocks 40 can be aligned with a frame 42 of the tree stand 14. Each of the brackets 12 includes a plurality of u-bolts 44 that extends through a respective one of the blocks 40. In this way each of the u-bolts 44 can secure the frame 42 of the tree stand 14 to the blocks 40 thereby attaching the brackets 12 to the tree stand 14.

A pair of side rail units 46 is included and each of the side rail units 46 slidably engages each of the brackets 12. Moreover, each of the side rail units 46 has a horizontally oriented element to inhibit a user 20 from falling sideways from the tree stand 14. Each of the side rail units 46 comprises a pair of downward members 48 that each has a top end 50, a bottom end 52 and an outside wall 54 extending therebetween. The outside wall 54 of each of the downward members 48 has a plurality of holes 56 extending therethrough, and the holes 56 are distributed between the top end 50 and the bottom end 52 of the downward members 48.

Each of the side rail units 46 includes a top member 58 that has a primary end 60, a secondary end 62 and a lower surface 64 extending therebetween. The top end 50 of each of the downward members 48 is coupled to the lower surface 64 of the top member 58 such that each of the downward members 48 is oriented perpendicular to the top member 58. A respective one of the downward members 48 is aligned with the primary end 60 and a respective one of the downward members 48 is positioned between the primary end 60 and the secondary end 62.

The second end 28 of each of the tubes 22 insertably receives the bottom end 52 of a respective one of the downward members 48 such the top member 58 is horizontally oriented. In this way the top member 58 of each of the side rail units 46 defines a horizontal element 66 to inhibit the user 20 from falling sideways from the tree stand 14. Each of the side rail units 46 includes a pair of pins 68 and each of the pins 68 associated with the side rail units 46 is extendable through the second portion 26 of a respective one of the tubes 22. Moreover, each of the pins 68 associated with the side rail units 46 engages a respective one of the holes 56 in a respective one of the downward members 48 for retaining the top member 58 at a selected height.

An arm 70 is provided and the arm 70 is pivotally coupled to a respective one of the side rail units 46. The arm 70 is positionable in a closed position having the arm 70 extending horizontally between the side rail units 46. In this way the arm 70 inhibits the user 20 from falling forwardly from the tree stand 14. Thus, the arm 70 and each of the side rail units 46 surround the user 20 when the user 20 is standing on the platform 16 of the tree stand 14 such that the user 20 is inhibited from falling off of the platform 16. The arm 70 is positionable in an open position having the arm 70 extending upwardly from the respective side rail unit 46 to facilitate the user 20 to enter or exit the tree stand 14.

The arm 70 has a first end 72 and a second end 74, and the first end 72 of the arm 70 is pivotally coupled to the secondary end 62 of the top member 58 of the respective side rail unit 46. The second end 74 of the arm 70 engages the secondary end 62 of the top member 58 of the side rail unit 46 to which the arm 70 is not pivotally coupled when the arm 70 is in the closed position. As is most clearly shown in FIG. 1, the top member 58 to which the arm 70 is not pivotally coupled may have a slot 76 extending downwardly therein which receives the arm 70 when the arm 70 is in the closed position.

In use, each of the brackets 12 is adjusted to the necessary width to align each of the blocks 40 with the frame 42 of the tree stand 14. In this way the u-bolts 44 can engage the frame 42 for attaching the brackets 12 to the frame 42. The height of each of the side rail units 46 is adjusted to position the top member 58 at a preferred height to inhibit the user 20 from falling sideways off of the platform 16. Additionally, the arm 70 is positioned in the closed position when the user 20 enters the platform 16. In this way the user 20 is inhibited from falling sideways or from falling forward from the platform 16. Thus, the user's 20 safety is enhanced with the user 20 is hunting from the platform 16 as is commonly practiced with deer hunting.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tree stand rail assembly having an adjustable safety rail for inhibiting a user from falling from a tree, said assembly comprising:
a pair of brackets, each of said brackets having an adjustable width wherein each of said brackets is configured to be adjusted to match a width of a tree stand, each of said brackets having an adjustable height wherein each of said brackets is configured to match a height of a user standing on the tree stand;
a pair of side rail units, each of said side rail units slidably engaging each of said brackets such that each of said side rail units has a horizontally oriented element wherein said horizontally oriented element is configured to inhibit a user from falling sideways from the tree stand; and
an arm being pivotally coupled to a respective one of said side rail units, said arm being positionable in a closed position having said arm extending horizontally between said side rail units wherein said arm is configured to inhibit the user from falling forwardly from the tree stand, said arm being positionable in an open position having said arm extending upwardly from said respective side rail unit wherein said arm is configured to facilitate the user to enter or exit the tree stand.

2. The assembly according to claim 1, wherein each of said brackets comprises a pair of tubes, each of said tubes having a first portion forming an angle with a second portion, each of said tubes having a first end, a second end and an outer wall extending therebetween, said first end being associated with said first portion, said second end being associated with said second portion.

3. The assembly according to claim 2, wherein said pair of tubes includes a first tube and a second tube, said first end of said first tube insertably receiving said first end of said second tube such that said second portion of each of said tubes are positionable an adjustable distance apart from each other.

4. The assembly according to claim 3, wherein said outer wall of said first portion of said second tube has a plurality of aperture extending therethrough, said apertures being distributed over a substantial length of said first portion.

5. The assembly according to claim 4, wherein each of said brackets includes a pin being extendable through said outer wall of said first portion of said first tube, said pin engaging a respective one of said apertures in said outer wall of said first portion of said second tube for retaining said first tube and said second tube at a selected width.

6. The assembly according to claim 3, wherein each of said brackets includes a pair of blocks, each of said blocks being coupled to and extending away from said outer wall corresponding to said first portion of a respective one of said tubes, each of said blocks being positionable a selected distance apart from each other when said first tube and said second tube are positioned at a selected width wherein said blocks is configured to be aligned with a frame of a tree stand.

7. The assembly according to claim 6, wherein each of said brackets includes a plurality of u-bolts, each of said u-bolts extending through a respective one of said blocks wherein each of said u-bolts is configured to secure the frame of the tree stand to said blocks thereby attaching said brackets to the tree stand.

8. The assembly according to claim 1, wherein each of said side rail units comprises a pair of downward members, each of said downward members having a top end, a bottom end and an outside wall extending therebetween, said outside wall of each of said downward members having a plurality of holes extending therethrough, said holes being distributed between said top end and said bottom end of said downward members.

9. The assembly according to claim 8, wherein each of said side rail units includes a top member having a primary end, a secondary end and a lower surface extending therebetween, said top end of each of said downward members being coupled to said lower surface of said top member such that each of said downward members is oriented perpendicular to said top member, a respective one of said downward members being aligned with said primary end, a respective one of said downward members being positioned between said primary end and said secondary end.

10. The assembly according to claim 9, wherein:
each of said brackets comprises a pair of tubes, each of said tubes having a first portion forming an angle with a second portion, each of said tubes having a first end, a second end and an outer wall extending therebetween, said first end being associated with said first portion, said second end being associated with said second portion; and
said second end of each of said tubes insertably receives said bottom end of a respective one of said downward members such said top member is horizontally oriented wherein said top member of each of said side rail units is configured to inhibit the user from falling sideways from the tree stand.

11. The assembly according to claim 10, wherein each of said side rail units includes a pair of pins, each of said pins associated with said side rail units being extendable through said second portion of a respective one of said tubes, each of said pins associated with said side rail units engaging a respective one of said holes in a respective one of said downward members for retaining said top member at a selected height.

12. The assembly according to claim 9, wherein said arm has a first end and a second end, said first end of said arm being pivotally coupled to said secondary end of said top member of said respective side rail unit, said second end of said arm engaging said secondary end of said top member of said side rail unit to which said arm is not pivotally coupled when said arm is in said closed position.

13. A tree stand rail assembly having an adjustable safety rail for inhibiting a user from falling from a tree, said assembly comprising:
a pair of brackets, each of said brackets having an adjustable width wherein each of said brackets is configured to be adjusted to match a width of a tree stand, each of said brackets having an adjustable height wherein each of said brackets is configured to match a height of a user standing on the tree stand, each of said brackets comprising:
a pair of tubes, each of said tubes having a first portion forming an angle with a second portion, each of said tubes having a first end, a second end and an outer wall extending therebetween, said first end being associated with said first portion, said second end being associated with said second portion, said pair of tubes including a first tube and a second tube, said first end of said first tube insertably receiving said first end of said second tube such that said second portion of each of said tubes are positionable an adjustable distance apart from each other, said outer wall of said first portion of said second tube having a plurality of aperture extending therethrough, said apertures being distributed over a substantial length of said first portion;
a pin being extendable through said outer wall of said first portion of said first tube, said pin engaging a respective one of said apertures in said outer wall of said first portion of said second tube for retaining said first tube and said second tube at a selected width;
a pair of blocks, each of said blocks being coupled to and extending away from said outer wall corresponding to said first portion of a respective one of said tubes, each of said blocks being positionable a selected distance apart from each other when said first tube and said second tube are positioned at a selected width wherein said blocks is configured to be aligned with a frame of a tree stand; and
a plurality of u-bolts, each of said u-bolts extending through a respective one of said blocks wherein each of said u-bolts is configured to secure the frame of the tree stand to said blocks thereby attaching said brackets to the tree stand;
a pair of side rail units, each of said side rail units slidably engaging each of said brackets such that each of said side rail units has a horizontally oriented element wherein said horizontally oriented element is configured to inhibit a user from falling sideways from the tree stand, each of said side rail units comprising:
a pair of downward members, each of said downward members having a top end, a bottom end and an outside wall extending therebetween, said outside wall of each of said downward members having a plurality of holes extending therethrough, said holes being distributed between said top end and said bottom end of said downward members;
a top member having a primary end, a secondary end and a lower surface extending therebetween, said top end of each of said downward members being coupled to said lower surface of said top member such that each of said downward members is oriented perpendicular to said top member, a respective one of said downward members being aligned with said primary end, a respective one of said downward members being positioned between said primary end and said secondary end, said second end of each of said tubes insertably receiving said bottom end of a respective one of said downward members such said top member is horizontally oriented wherein said top member of each of said side rail units is configured to inhibit the user from falling sideways from the tree stand; and
a pair of pins, each of said pins associated with said side rail units being extendable through said second portion of a respective one of said tubes, each of said pins associated with said side rail units engaging a respective one of said holes in a respective one of said downward members for retaining said top member at a selected height; and
an arm being pivotally coupled to a respective one of said side rail units, said arm being positionable in a closed position having said arm extending horizontally between said side rail units wherein said arm is configured to inhibit the user from falling forwardly from the tree stand, said arm being positionable in an open position having said arm extending upwardly from said respective side rail unit wherein said arm is configured to facilitate the user to enter or exit the tree stand, said arm having a first end and a second end, said first end of said arm being pivotally coupled to said secondary end of said top member of said respective side rail unit, said second end of said arm engaging said secondary end of said top member of said side rail unit to which said arm is not pivotally coupled when said arm is in said closed position.
